(19) United States
(12) Patent Application Publication
(10) Pub. No.: US 2003/0090453 A1
(43) Pub. Date: May 15, 2003

(54) Method and apparatus for localizing graphics

(76) Inventor: Olivier Fischer, Cincinnati, OH (US)

Correspondence Address: WATTS, HOFFMANN, FISHER & HEINKE CO., L.P.A., P.O. Box 99839, Cleveland, OH, 44199-0830, US

(21) Appl. No.: 10/008,550

(22) Filed: Nov. 13, 2001

(51) Int. Cl. G09G 3/36

(52) U.S. Cl. 345/100

(57) ABSTRACT

A method and apparatus for localizing a target graphic containing textual elements based on a first geographical region. Textual elements are extracted from the target graphic. The extracted textual elements are stored as a first set of textual element records to be modified based on the language and/or customs of a second geographical region to form a second set of textual element records. The first set of textual element records is accessed and modified to form the second set of textual element records. Modified textual elements are imported from the second set of textual element records into the target graphic. The sets of textual elements may be stored in database form for a plurality of geographic regions and a glossary may be provided to assist in the localization.

### TECHNICAL FIELD

This invention generally relates to systems and processes used for generating graphics, and more specifically to a system for use in translating and adapting a graphic designed for use in one country to one which is usable in another country. This process of translation and adaptation is generally referred to as “localization” of the target graphic.

### BACKGROUND OF THE INVENTION

As companies become more global geographically, it becomes essential for them to provide marketing and other information in a wide range of languages and adapted to local cultures around the world. In particular they have to adapt the graphics used in their business, such as marketing related graphics, to accommodate the language, customs and culture of the individual target markets.

This “localization” of graphics products generally includes translating textual components and changing the time, date, decimal and currency formats. In addition, the graphics must also be modified to accommodate local laws and customs. The translation of textual components may be quite challenging. Different cultures and countries have different rules for punctuation, word order, number formats and other local idiosyncrasies. For example, far eastern countries have alphabets that include many thousands of characters (requiring multiple bytes of data to represent a single character) whereas the ASCII character set used in the United States numbers less than 256 characters (which can be accommodated by a single 8 bit byte). Many native languages and customs have different meanings for certain symbols used as computer icons as well as colors which may be used to indicate some special meaning.

Localization of a graphic from one locale to another to accommodate such differences typically involves translation of the textual messages embedded in the graphic into the new language, adapting the graphic to accommodate the customs and conventions of the new locale; and testing and assurancing that the modified graphic works as intended.

As can be seen from the foregoing, the process of localization is very labor intensive. In the area of graphics, localization must be done by people who know both the native language of the new country as well as the basics of graphic design and construction. In the area of computer programs, localization must be done by people who know the native language of the new country as well as the basics of computer program architecture and construction. An example of the process of localization in the area of computer programs is thoroughly described in the book entitled “Writing Localizable Software for the Macintosh.RTM.” by Daniel R. Carter, Addison-Wesley Publishing, 1992, ISBN 0-201-57013-0. (MACINTOSH is a registered trademark of Apple Computer, Inc.).

Much progress has been made in designing and writing computer software to make the process of “localizing” a computer program easier by the use of special data bases of internal messages instead of embedding them at various places in the code, by establishing special resource files to specify formats for time, currency, numbers, units of measure, etc., and generally providing interfaces that can be modified dynamically to change from one environment to another. This way of designing and producing software that can be easily adapted to local markets is defined as “INTERNATIONALIZATION”. See for example, “Solaris.RTM. International Developer's Guide” by Bill Tuthill, SunSoft Press (Prentice Hall), 1993, ISBN 0-13-031063-8. (SOLARIS is a registered trademark of Sun Microsystems, Inc.).

The basic localization process, whether for computer programs or graphics, is at best extremely difficult and time consuming, requiring personnel with an unusual amount of training in the local languages, customs, mores as well as in the art of the computer development, and /or graphic design and production, modification and testing. A computer software vendor or a graphics publisher is faced with hiring internal staff familiar with each country and training them to provide the localization services for their native country. Finding, hiring and training such individuals is a very costly undertaking. Moreover, the complexity of the present processes and procedures makes the likelihood of induced errors very high, and the additional effort in testing and error correction very costly. Additionally, customers are demanding consistency in the localization of different releases of the same product (graphic or computer program) as well as demanding new releases be made available to them either at the same time as new releases are announced in the U.S. or shortly thereafter.

### SUMMARY OF THE INVENTION

By extracting the textual elements of a target graphic and storing them as a separate entity from the graphic, the process of localizing a graphic is simplified because the translation of the textual elements can be completed by a translator without the need to access and deconstruct the target graphic.

According to the present invention, a method and apparatus for localizing a target graphic containing textual elements based on a first geographical region are provided. Textual elements are extracted from the target graphic. The extracted textual elements are stored as a first set of textual element records to be modified based on the language and/or customs of a second geographical region to form a second set of textual element records. The first set of textual element records is accessed and modified to form a second set of textual element records. Modified textual elements are imported from the second set of textual element records into the target graphic. The sets of textual elements may be stored in database form for a plurality of geographic regions and a glossary may be provided to assist in the localization.

These and other objects, advantages, and features of the invention will be better understood from the accompanying detailed description of a preferred embodiment of the invention when reviewed in conjunction with the accompanying drawings.

### BRIEF DESCRIPTION OF THE DRAWINGS

The objects, features and advantages of the system of the present invention will be apparent from the following description in which:

FIG. 1 illustrates an exemplary computer system;

FIG. 2 illustrates the general localization process according to one embodiment of the present invention;

FIG. 3 illustrates a block diagram of the high level activities of the localization process of one embodiment of the present invention; and

FIG. 4 is a diagram of a user interface display according to one embodiment of the present invention.

### DETAILED DESCRIPTION OF THE PREFERRED EMBODIMENT

The detailed description that follows is presented in terms of program procedures executed on a computer or network of computers. These procedural descriptions and representations are the means used by those skilled in the art to most effectively convey the substance of their work to others skilled in the art.

The present invention also relates to apparatus for performing these procedures. This apparatus may be specially constructed for the required purposes or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

A process for localizing a target graphic product makes use of a localization kit containing tools to automatically guide a user in the steps necessary to localize the target product and to automate and control the process of assembly and test of the localized version of the product. The disclosed apparatus and process permit a graphic publisher to contract with a local translator to develop a localized version of a target graphic product by supplying the translator access to the target graphic or to only the textual elements of said graphic (typically in a database format) after the textual elements have been extracted from the electronic version of the target graphic using the first phase of the process described here and a localization kit (typically stored on a CD-ROM). The implementation of the invention, while it may be used in any relevant context with any graphic product, is described here in the context of a particular target graphic product for illustrative purposes. However, no specific knowledge of the illustrated system should be required by those skilled in these arts to understand and implement the process and system described in this disclosure.

Operating Environment

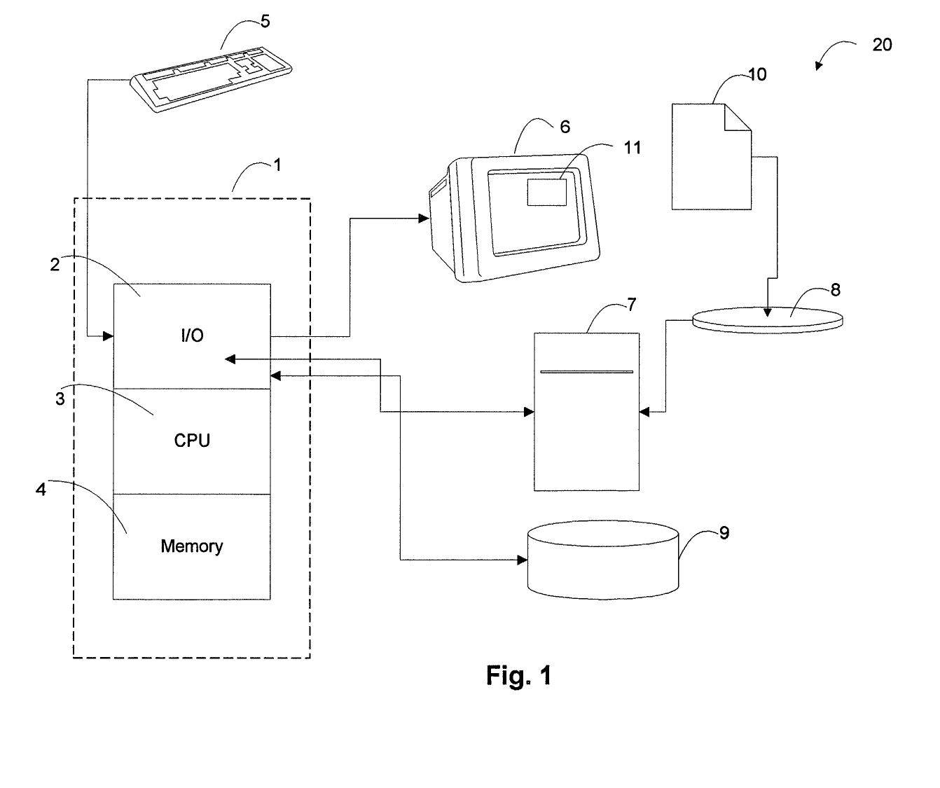

The environment in which the present invention is used is depicted in FIG. 1. The environment encompasses a general distributed computing system, wherein general purpose computers, workstations, or personal computers are connected via communication links of various types, in a client-server arrangement, wherein programs and data, many in the form of objects, are made available and shared by various members of the system for execution and access by other members of the system. A general purpose workstation computer 20 has a processor 1. The processor indicated generally as 1 may include an input/output (“I/O”) section 2, a central processing unit (“CPU”) 3, and a memory section 4. The I/O section 2 may be connected to a keyboard 5, a display unit 6, a disk storage unit 9 and a CD-ROM drive unit 7. The CD-ROM unit 7 can read a CD-ROM medium 8 that typically contains programs 10 and data. A computer display icon 11 is shown on the display unit 6. Similar workstations may be connected by a communications path to form a distributed computer system.

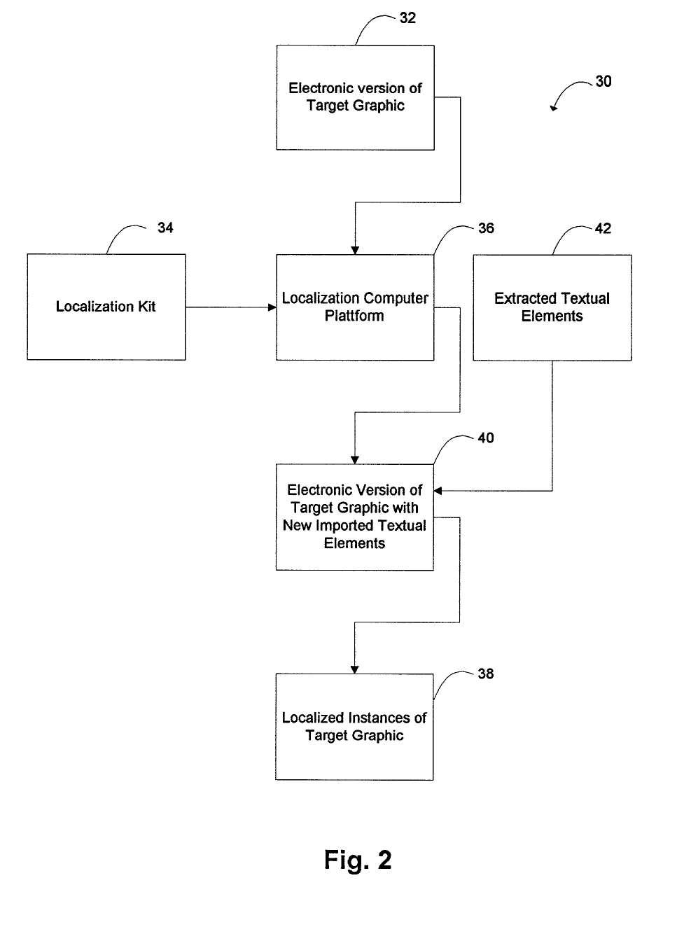

Referring now to FIG. 2 a block diagram of a localization system 30 shows a target graphic product in binary form 32 (this is generally in CD-ROM form), a localization kit 34 (which is also typically in CD-ROM form), a localization machine platform (typically a computer workstation) 36, extracted textual elements 42 an electronic version of target graphic with new imported textual elements 40, and a localized version of the target graphic product binary 38. In one embodiment, the localization machine platform has the following configuration, 1) ×86-based system with a CD-ROM drive; 2) at least 96 Mbytes of system RAM memory; and 3) at least 50 Mbytes of available disk space. In the embodiment, an electronic version of the target graphic product is loaded into the localization machine platform 36. The localization kit 34 is then loaded into the localization machine platform 36, and the textual components are extracted from the said graphic and stored in the extracted textual element database 42. The translator is then given access to this database, but not necessarily to the original graphic. The localization kit guides the localization translator through the steps of localizing those portions of the target graphic which require localization. The localization kit 34 then imports the localized materials into an electronic version of the target graphic product 32, to produce an electronic version of the target graphic with new imported textual elements 40, and in the next phase produces the localized version of the target graphic product 38.

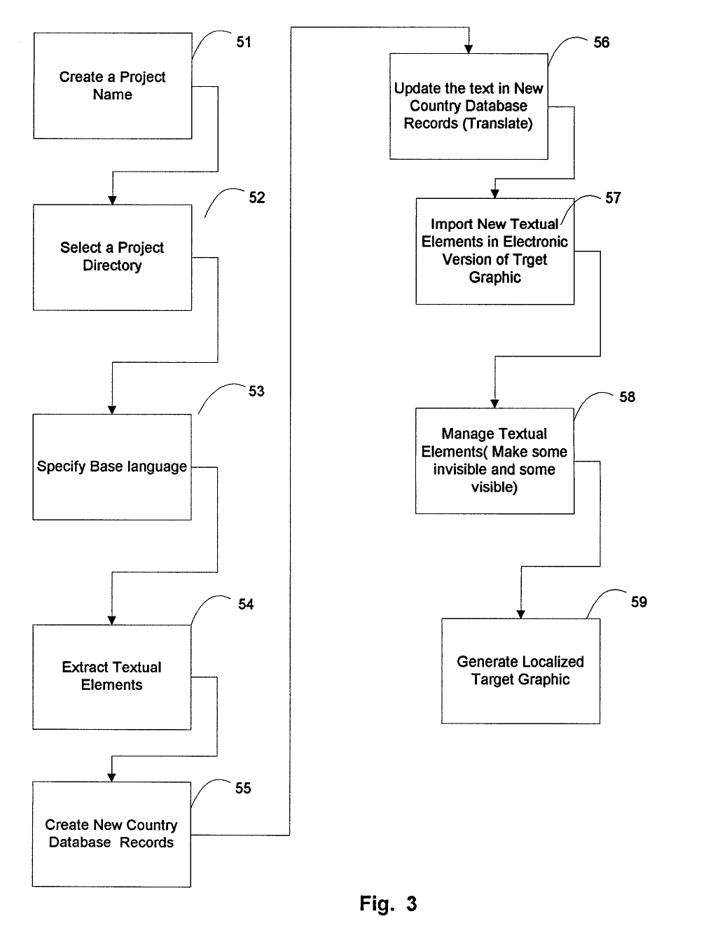

The steps followed in localizing a graphic according to an embodiment of the present invention are summarized in FIG. 3. The user inputs the name of an existing project or creates a new project in step 51. A project is defined by a project name, a base language, and a directory. A project represents a set of file which needs to be localized from the base country to one or many other countries. The first time the user works on a set of file, he/she need to define a project. The user gives the project a name, selects the directory on the computer system where the target graphics are stored in step 52, and selects the name of the base country in step 53. For example if the graphics were designed for use in the USA, then the base country will be USA. When the user is done defining the project, the localization kit builds the appropriate database representation of the new project, and creates and stores in localization database (created in step 54) a project record that stores the name of the project, the base country, and the directory for this project and a file record for each of the graphics files in the project directory and its subdirectories. The localization kit then accesses all the graphics files in the project directory and its subdirectories, looks for all the textual elements in these graphics, and stores them in the localization database 54.

The localization database thereby stores a representation of all the textual elements in each graphic, as well as an indication of what language each textual element is in. In one embodiment, the textual data from the target graphic is obtained by reading the binary Adobe Photoshop file. The file format for Adobe Photoshop files is publicly available on the web site of Adobe, at www.adobe.com. To extract the text from the text layer in Adobe Photoshop, the IMPORT algorithm shown in Table 1 can be used to extract the textual elements (step 54 FIG. 3) from the graphic file:

TABLE 1
For all elements in the selected directory do
If the element is a directory, then call this algorithm recursively

Else
Create a record in the database for the file
Read the number of layers in the file

For each layer

For all elements in the selected directory do
If the layer is a text layer, then read the text and store it
in the database in a new text layer record associated with
the current file record. (The layer is a text layer if its
key is TySh)

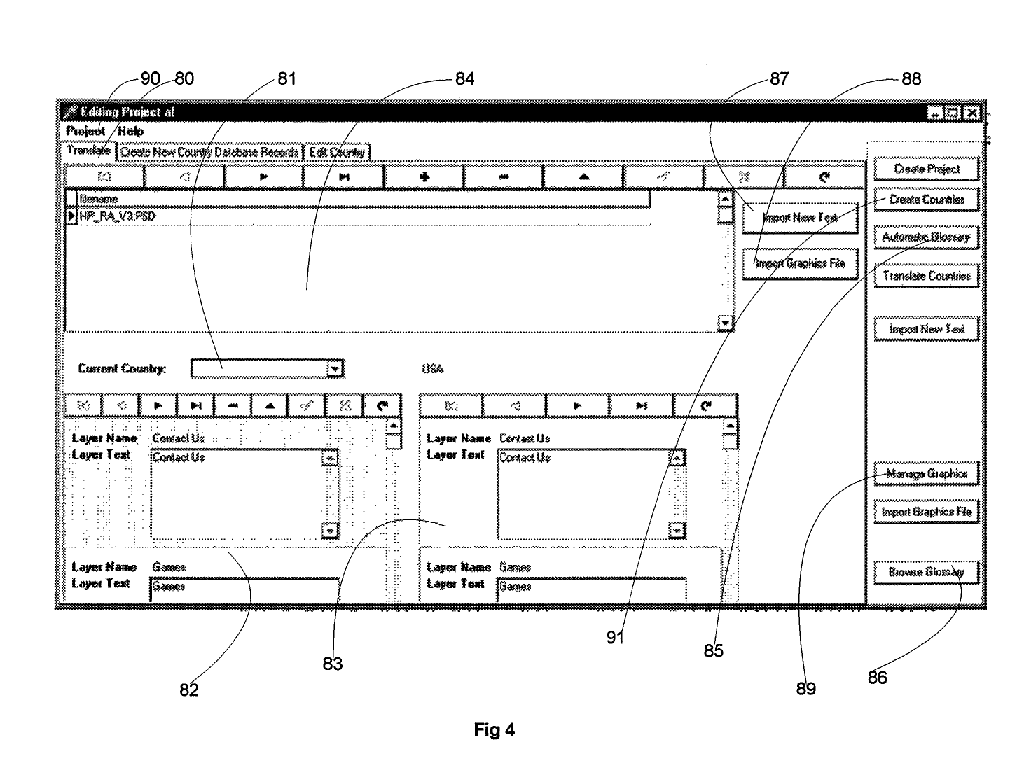

A user interface display screen that is used to localize graphics according to an embodiment of the present invention is depicted in FIG. 4. At any point a new file may be added to the system by using the import graphics file functionality, accessed by pressing an import graphics button 88. This button lets the user select a file and runs the above IMPORT algorithm on this file to extract the textual information from the graphic as a set of extracted text database records, separate from the graphic itself. Therefore, the textual information can be now be localized by accessing the extracted text database records without the necessity of accessing the original Photoshop graphic file. This lack of access might be beneficial to protect the original files against unwarranted uses.

Referring now to FIGS. 3 and 4, new records for a given country are created by actuating button 91 in FIG. 3 to perform step 55, create new country database records. The user is presented with a list of countries. If the user wants to localize the graphics to a country that does not appear in the list, he/she can create a new country. Otherwise, the user selects the country and clicks a “Create Records for Current Country” button found on the “Create New Country Database Record” tabbed page (not shown). When the user clicks the button, all the database records that represent files and textual elements for the original Photoshop files, i.e. the files for the base country, in this project in the database are duplicated and the country for them is reset to the new country.

To update the text in the new country database records (step 56 FIG. 3), the user now goes back to the “Translate” page tab 80. The user selects a country in the “Current Country” drop down box 81. The database records representing the textual elements for each file for this country appear below in 82. If they have just been created, they still have the same content as the corresponding textual elements in the base country that appear in 83. At the top of the screen is a list 84 of all the graphics files for this project. When a file in the list is selected, all the textual elements for this file appear in the lists below. The user can now select any of these textual elements and modify the text to change it to what should appear in the target graphic for the new language 56, that is for the current country. The textual records for the base country are always displayed on the right in the base country box 83. As the user selects a textual record for the new country, the corresponding textual record for the base country is highlighted in order to facilitate the translator's work. As the translator updates the text on the screen and moves from one record to another, the text is automatically updated in the database.

At any point in time, but most likely before the user starts the manual translation of the textual elements, the user can click on the “Automatic glossary” button 85. The localization will then scan the textual elements for the base country for glossary items that are in its glossary. If it finds any, it will suggest the equivalent term from the glossary for the current country. At any point in time, the translator can access the glossary manually by clicking the “Browse Glossary” button 86.

At any point, but most likely when the user has translated all the text for a given language, the user can import the new textual elements in the target graphic (step 57 FIG. 3). Once again, the user at step 57 could be a different user from the user at step 56. This is done by clicking the “Import New Text” button 87 (FIG. 4). The new textual elements are imported and grouped. The textual elements for the base country are also grouped, if they were not originally grouped. In the described embodiment, this grouping is done by putting all the textual elements which are in the form of type layers, in the same Photoshop layer set. One layer set is created for each country. Having one layer set per country facilitates the management of these layers, making them visible or invisible, including them in the final generated graphic or not. In the described embodiment, the importing of the text, the creation of new type layers, and of country layer sets, the moving and grouping of layers is all done using OLE automation.

The OLE automation has been optimized by building several higher level functions/procedures. Each of these functions/procedures encapsulate a series of calls to lower levels internal Photoshop functions/behaviors. Many of these lower levels calls were obtained by reading the Adobe Photoshop SDK available on the Internet and by using the Listener plugin for Photoshop. The listener plugin is a utility available on the Adobe Internet site. It traces commands generated when using the regular menu driven Photoshop application. One can perform operations using Photoshop and get, in a text file generated by the plugin, the C++ code equivalent to the operations shown in Table 2.

TABLE 2

| Function/procedures Name | Argument(s) | Behavior/results |
|---|---|---|
| changelayertext | Layer reference | Replace the text in the |
| | Text string | layer by the text given |
| | | as argument |
| MyOpenPSDFile | File name | opens the file in |
| | | photoshop |
| MyClosePSDFile | File Name | Closes the file |
| HideALayer | Layer reference | Hides the layer |
| DuplicateALayer | Layer reference new | Duplicates a layer and |
| | layer name (text | names it using the text |
| | string) | string passed as |
| | | argument |
| CreateALayerSet | Layer set name (text | Creates a new layer |
| | string) | sets and names it using |
| | | the text string passed |
| | | as argument |
| MoveLayer | Layer set name and | Moves the layer by |
| | layer name (both | that name into the |
| | passed as string | layer set by that name |
| ListExistingLayers | | Makes a list of all ht |
| | | enames of the existing |
| | | layer in th esurrent |
| | | Photoshop file. |
| SelectALayer; | Layer name (as a | This makes the layer |
| | text string) | by the name of the |
| | | layer name passed the |
| | | current layer in |
| | | Photoshop |
| LayerExists | Layer name (passed | Tests whether a layer |
| | as string) | by that name exists in |
| | | the current Photoshop |
| | | file. |
| BackgroundLayerExists | | returns true if the |
| | | current Photoshop file |
| | | has a background |
| | | layer, False if it does |
| | | not. |

The user can modify these new textual elements by going to the localization toolkit “Translate” tab, modifying text in one or several of the records and clicking the “Import New Text” button 87. The “Import New Text” functionality knows when a textual component needs to be created, and when it only needs to be updated. The process described above can be repeated for as many languages as the target graphic needs to be localized for.

The translation kit also helps manage the target graphic file after new textual components have been generated. The user can use the “Manage Graphics” 89 functionality to make textual components for given countries appear or disappear (step 58 FIG. 3), and to generate/save final graphics 59.

The user of this system has access to all past project that were created, and can delete them, open them to update textual components, manage target graphics, or import new graphics into the project. The user can access projects by using the “Select project” menu item under the “Project” menu 90, and selecting a project from a drop down list that lists all the projects in the system.

If access to the target graphic needs to be denied to the translator, the translator is provided with a subset of the localization system which can only access the database, not the graphics. The translator can still perform the translation by performing step 56 on the extracted textual element database records. Another user may perform the other steps which require access to the graphics.

Although the present invention has been described with reference to particular operating systems, graphics software package, program code mechanisms, and object and object reference definitions, it will be appreciated by one skilled in the art that the present invention may be implemented in any one of a number of variations within a given operating environment, or in different operating system or object system environments. Similarly, particular computer client and server configurations or combinations illustrated are only representative of one of many such configurations of clients and servers and object and sub-object relationships which may use the present invention. Moreover, it will be understood that the figures are for illustration only and should not be taken as limitations on the invention. Some additional combinations of the localization kit tools with other functions include the combining of the Glossary or translation tools with a different Graphical User Interface (“GUI”) agent that provides a friendly user interface to other target objects; the combining of the localization tools with an artificial intelligence agent which modifies remote requests based upon the user's known preferences; the combining of the CAGLOTool with a caching program that caches remote translation or localization requests; the combining of the localization tools with machine translation utilities; or the combining of a localization kit with a number of audio and video accessing agents in a multimedia system. These possible localization kit tools/applications combinations are not intended to limit in any way the possible uses of the localization kit functions as disclosed herein, but merely represent some examples which those skilled in these arts will recognize as merely exemplary.

Although the present invention has been described with a degree of particularity, it is the intent that the invention include all modifications and alterations from the disclosed design falling within the spirit or scope of the appended claims.

What is claimed is:

1. A method for localizing a target graphic containing textual elements based on a first geographical region comprising the steps of:
extracting textual elements from the target graphic; and
storing the extracted textual elements as a first set of textual element records to be modified based on the language and/or customs of a second geographical region to form a second set of textual element records.

2. The method of claim 1 further comprising the steps of accessing the first set of textual element records and modifying them to form the second set of textual element records.

3. The method of claim 1 further comprising the step of importing modified textual elements from the second set of textual element records into the target graphic.

4. The method of claim 1 wherein the set of textual element records comprises a plurality of records stored in a database.

5. The method of claim 1 further comprising providing a glossary containing translations for selected textual elements in a plurality of languages.

6. The method of claim 1 wherein the step of storing the textual elements is performed by grouping the textual elements in layers.

7. The method of claim 6 further comprising selecting layers from the set of textual element records to make visible in the target graphic.

8. The method of claim 1 wherein the target graphic has a plurality of layers and wherein the step of extracting textual elements from the target graphic is performed by:
creating a database for storing textual elements;
examining each layer to determine if the layer is a text layer, and if a layer is a text layer, storing the text in the text layer in the database; and
repeating the steps until all layers of the target graphic have been examined.

9. The method of claim 8 wherein the step of examining each layer is performed by examining a key for each layer.

10. A method for creating a database containing sets of textual element records for a target graphic having a plurality of layers and wherein the database contains a set of textual element records for the target graphic for each of a plurality of geographic regions, the method comprising:
examining each layer to determine if the layer is a text layer, and if a layer is a text layer, storing the text in the text layer in the database as a set of textual element records corresponding to an initial geographical region;
modifying the set of textual elements records based on a new geographical region;
storing the set of modified textual element records in a database location corresponding to the new geographical region; and
repeating the modifying and storing steps as necessary to create database records for all of the plurality of geographical regions.

11. The method of claim 10 wherein the step of examining each layer is performed by examining a key for each layer.

12. A computer readable medium having computer executable instructions stored thereon for localizing a target graphic containing textual elements based on a first geographical region, wherein the computer executable instructions are for performing the steps of:
extracting textual elements from the target graphic;
storing the extracted textual elements as a first set of textual element records to be modified based on the language and/or customs of a second geographical region to form a second set of textual element records;
accessing the second set of textual element records for the second geographical region;
modifying the first set of textual element records to form the second set of textual element records; and
importing modified textual elements from the second set of textual element records into the target graphic.

13. The computer readable medium of claim 12 further comprising computer executable instructions for providing a glossary containing translations for selected textual elements in a plurality of languages.

14. The computer readable medium of claim 12 wherein the target graphic has a plurality of layers and wherein the instructions for performing the step of extracting textual elements from the target graphic comprise instructions for:
creating a database for storing textual elements;
examining each layer to determine if the layer is a text layer, and if a layer is a text layer, storing the text in the text layer in the database; and
repeating the steps until all layers of the target graphic have been examined.

15. A computer readable medium having computer executable instructions stored thereon for creating a database containing sets of textual element records for a target graphic having a plurality of layers and wherein the database contains a set of textual element records for the target graphic for each of a plurality of geographic regions, wherein the computer executable instructions are for:
examining each layer to determine if the layer is a text layer, and if a layer is a text layer, storing the text in the text layer in the database as a set of textual element records corresponding to an initial geographical region;
modifying the set of textual elements records based on a new geographical region;
storing the set of modified textual element records in a database location corresponding to the new geographical region; and
repeating the modifying and storing steps as necessary to create database records for all of the plurality of geographical regions.

16. The computer readable medium of claim 15 wherein the step of examining each layer is performed by examining a key for each layer.

17. An apparatus localizing a target graphic containing textual elements based on a first geographical region comprising:
means for extracting textual elements from the target graphic;
means for storing the extracted textual elements as a first set of textual element records to be modified based on the language and/or customs of a second geographical region to form a second set of textual element records;
means for accessing the first set of textual element records to form the second set of textual element records; and
means for importing modified textual elements from the second set of textual element records into the target graphic.
